(19) United States
(12) Patent Application Publication
(10) Pub. No.: US 2011/0084796 A1
(43) Pub. Date: Apr. 14, 2011

(54) METHOD AND SYSTEM FOR SECURE RFID COMMUNICATION BETWEEN A NOISY READER AND A COMMUNICATING OBJECT

(75) Inventor: Olivier SAVRY, Sassenage (FR)

(73) Assignee: COMMISSARIAT A L'ENERGIE ATOMIQUE ET AUX ENE. ALT., Paris (FR)

(21) Appl. No.: 12/899,852

(22) Filed: Oct. 7, 2010

(30) Foreign Application Priority Data
Oct. 9, 2009 (FR) 09 57085

(51) Int. Cl. G06F 7/04

(52) U.S. Cl. 340/5.8

(57) ABSTRACT

A method for communication between a RFID noisy reader (100) and a RFID communicating object, including a method for authenticating the noisy reader done between the noisy reader and the communicating object before a transmission of data from the communicating object to the noisy reader, said data transmission being subject to a valid authentication of the noisy reader by the communicating object, and wherein the authentication method is implemented at the same time as an anti-collision method between the noisy reader and at least the communicating object.

### TECHNICAL FIELD

The invention concerns the field of communications, or teletransmissions, of the RFID (Radio Frequency Identification) type between portable communicating objects (contactless cards, tickets, tags or labels, . . . ) and a noisy reader, for example connected by inductive coupling. The invention is particularly applicable to the fields of object identification, access control, or toll charge using contactless devices (such as cards).

### BACKGROUND OF THE INVENTION

RFID tags, or labels, and contactless cards are devices that, during communication with a RFID card and/or tag reader, are remotely power fed by the reader and have a small energy budget at their disposal to operate. They can therefore perform only simple computations in a reasonable time. It is therefore not possible for these RFID cards or tags to implement sophisticated encryption algorithms that would allow them to ensure good security of their communications with the RFID reader without considerably increasing the complexity of these RFID contactless cards or tags as well as the energy they require. Communications between a RFID reader and a RFID tag or contactless card are therefore generally unsecured. The absence of security in these communications means that any ill-intentioned person can easily listen to the transaction or exchange of data between a reader and a tag or contactless card. For example, such eavesdropping on the unique identification code (UID) or electronic product code (EPC) transmitted by the RFID tag or contactless card to the reader can then make it possible to follow that tag or card, and therefore the person carrying it, thereby compromising the protection of that person's private life.

To resolve this security problem related to eavesdropping on communications between a RFID reader and a tag or a contactless card, document WO 2006/035178 A1 proposes a solution consisting of securing the communications between the reader and the tag or the contactless card. This method uses a specific reader called a “noisy reader.” Unlike a traditional RFID reader transmitting a constant amplitude carrier wave to feed the tag or card during the response by that tag or card to the reader, the noisy reader transmits, during a response from the queried tag or card, a carrier wave modulated by noise making it possible to mask the load modulation done by the tag or the card to answer the reader. Thus, a spy probe arranged in the communication field of the reader with the tag or the card will then only see noise and will not be able to understand the message sent by the tag or card whereas the reader, knowing the noise transmitted through the carrier, will be capable of removing the noise from the message sent by the tag or card to find the original message from the tag or card again.

Although the use of the noisy reader is effective against eavesdropping on communications between the reader and a RFID communicating object, anyone can, however, initiate a communication with the RFID tag or the contactless card by using a traditional non-noisy reader and, by transmitting the same commands as those transmitted by the noisy reader, obtain responses from the tag or card, and in particular identification data of the tag or contactless card that one was seeking to mask via the noise emitted on the carrying wave by the noisy reader.

### BRIEF DESCRIPTION OF THE INVENTION

Thus there is a need to propose a method for secure communication between a RFID noisy reader and a RFID communicating object such as a RFID tag or RFID contactless card, making it possible in particular, in addition to securing the data transmitted by the communicating object to the noisy reader, to completely secure the communication channel between the reader and the communicating object, i.e. making it possible also to secure data exchanges from the reader to the tag or card.

To do this, it is proposed a communication method between at least one RFID noisy reader and at least one RFID communicating object, including at least one method for authenticating the noisy reader done between the noisy reader and the communicating object before a transmission of data from the communicating object to the noisy reader, said data transmission being subject to a valid authentication of the noisy reader by the communicating object.

The method thus prevents a non-validated reader, i.e. an unauthorized reader such as for example a non-noisy reader, from requesting information from the communicating object, while ensuring the security of the exchanges owing to the noise implemented by the noisy reader, which prevents listening to the exchanges between the reader and the communicating object.

Moreover, such authentication does not involve using a complex encryption method, and therefore does not affect the material resources and energy budget necessary for the communicating object. This method therefore ensures authentication of the reader by the communicating object without adding a large number of additional logic components into the communicating object and the reader.

The term “communicating RFID object” here refers to any type of object capable of communicating by RFID with a RFID reader, such as for example RFID tags or labels, or RFID contactless cards.

The transmission of data subject to a valid authentication of the noisy reader may be a transmission of identification data of the communicating object.

The authentication method may be implemented at the same time as an anti-collision method between the noisy reader and at least the communicating object. Thus, the implementation of the authentication method does not affect the total duration of a communication between the noisy reader and the communicating object. Moreover, compared to a sequential implementation of a method for authenticating the reader and of an anti-collision method which requires a longer duration of the communication between the reader and the communicating object, an implementation of the method for authenticating the reader at the same time as the anti-collision method enables a reduction of the energy required for this authentication and this anti-collision method, given that the duration of the communication between the noisy reader and the communication object is reduced.

The authentication method may include at least the following steps:
generating a first pseudorandom number from a physical pseudorandom number generator of the communicating object,
masking the first pseudorandom number with at least one bijective encryption function;
sending, from the communicating object to the noisy reader, the first masked pseudorandom number,
unmasking of the first pseudorandom number by the noisy reader,
generating a second pseudorandom number from the first pseudorandom number used as seed for a pseudorandom number generator of the communicating object,
generating a third pseudorandom number from the first pseudorandom number used as seed for a pseudorandom number generator of the noisy reader similar to the pseudorandom number generator of the communicating object,
sending, from the noisy reader to the communicating object, the third pseudorandom number,
comparing the second pseudorandom number with the third pseudorandom number by the communicating object, the noisy reader being identified as valid when the second pseudorandom number is similar to the third pseudorandom number.

The authentication method can therefore use pseudorandom number generators already present in the noisy reader and the communicating object and used during the communication method between the reader and the communicating object, for example during an anti-collision phase of the communication method. In relation to a standard communication protocol between a noisy reader and a RFID communicating object, the authentication method therefore uses an additional masking/unmasking function and registers, or logs, making it possible to compare the pseudorandom numbers generated by the communicating object and by the reader, which is negligible in terms of complexity for the communicating object and the reader.

Furthermore, the first pseudorandom number may be generated by a physical pseudorandom number generator, or True Random Number Generator (TRNG), of the communicating device making it possible to generate the first pseudorandom number for example from the thermal noise of a component (resistance, diode, . . . ), a desynchronization between two clocks or the output value of a SRAM cell just after its initialization, its output randomly assuming the value 0 or 1 (see for example document “RFID Noisy Reader How to Prevent from Eavesdropping on the Communication ?” by O. Savry et al., CHES 2007, LNCS 4727, pages 334-345, 2007).

The bijective encryption function used to mask the first pseudorandom number may include at least one Exclusive OR operation done between the first pseudorandom number and a secret key known by the communicating object and the noisy reader, and the unmasking of the first pseudorandom number by the noisy reader may include at least one Exclusive OR operation done between the first masked pseudorandom number and the secret key.

The first, second and third pseudorandom numbers may be at least 16-bit binary numbers.

The communication method may also include, before the step for generating the first pseudorandom number, a step for selecting, among several communicating objects found in the communication field of the noisy reader, part of the communicating objects, and a step for assigning distinct communication time slots to each of the selected communicating objects.

The step for generating the first pseudorandom number may include generating a pseudorandom number by the physical pseudorandom number generator, then generating the first pseudorandom number from said pseudorandom number used as seed by the pseudorandom number generator of the communicating object. Thus, the first pseudorandom number may be obtained directly as output from the physical pseudorandom number generator, or obtained by generating a pseudorandom number beforehand by the physical pseudorandom number generator, which is then used as seed by the pseudorandom number generator of the communicating object, which even further reinforces, from a statistical perspective, the pseudorandom nature of the first pseudorandom number.

It is also proposed a RFID noisy reader, including means for carrying out a communication method as previously described with at least one RFID communicating object.

It is also proposed a RFID communicating object, including means for carrying out a communication method as previously described with at least one RFID noisy reader.

Said communicating object may include at least one RFID tag and/or at least one RFID contactless card.

Lastly, it is also proposed a RFID communication system including at least one RFID noisy reader and at least one RFID communicating object, in which the noisy reader and the communicating object include means for carrying out an authentication method of the noisy reader between the noisy reader and the communicating object before transmitting data from the communicating object to the noisy reader, said data transmission being subject to a valid authentication of the noisy reader by the communicating object.

The communication system may also include means for carrying out an anti-collision method between the noisy reader and at least the communicating object.

This implementation of the anti-collision method between the noisy reader and at least the communicating object may be at the same time as the implementation of the authentication method of the noisy reader.

The communicating system may include at least:
means for generating a first pseudorandom number from a physical pseudorandom number generator of the communicating object,
means for masking the first pseudorandom number with at least one bijective encryption function;
means for sending, from the communicating object to the noisy reader, the first masked pseudorandom number,
means for unmasking of the first pseudorandom number by the noisy reader,
means for generating a second pseudorandom number from the first pseudorandom number used as seed for a pseudorandom number generator of the communicating object,
means for generating a third pseudorandom number from the first pseudorandom number used as seed for a pseudorandom number generator of the noisy reader similar to the pseudorandom number generator of the communicating object,
means for sending, from the noisy reader to the communicating object, the third pseudorandom number,
means for comparing the second pseudorandom number with the third pseudorandom number by the communicating object, the noisy reader being identified as valid when the second pseudorandom number is similar to the third pseudorandom number.

The means for carrying out the authentication method may be made in the form of a control unit controlling the different elements (registers, pseudorandom number generators, . . . ) of the reader or communicating object.

The masking means may include at least one Exclusive OR operator capable of performing an Exclusive OR operation between the first pseudorandom number and a secret key known by the communicating object and the noisy reader, and the unmasking means may include at least one Exclusive OR operator capable of performing an Exclusive OR operation between the first masked pseudorandom number and the secret key.

The communication system may also include means for selecting, among several communicating objects located in the communication field of the noisy reader, part of the communicating objects, and means for assigning distinct communication time slots to each of the selected communicating objects.

The means for generating the first pseudorandom number may include means for generating a pseudorandom number by the physical pseudorandom number generator and means for generating the first pseudorandom number from said pseudorandom number used as seed by the pseudorandom number generator of the communicating object.

### BRIEF DESCRIPTION OF THE DRAWINGS

The present invention will be better understood upon reading the description of embodiments provided solely for information and in no way limitingly, done in reference to the appended drawings, in which:

FIG. 1 illustrates a diagram of a RFID noisy reader made according to a specific embodiment and capable of carrying out a secure communication method with a RFID communicating object;

FIG. 2 illustrates a diagram of a RFID communicating object made according to one specific embodiment and capable of carrying out a secure communication method with a RFID noisy reader,

FIG. 3 illustrates steps of a secure communication method between a RFID noisy reader and a RFID communicating object according to one specific embodiment.

Identical, similar or equivalent parts of the different figures described below bear the same numerical references so as to facilitate the transition from one figure to the next.

The different parts illustrated in the figures are not necessarily shown using a uniform scale, to make the figures more legible.

The different possibilities (alternatives and embodiments) must be understood as not being mutually exclusive and can be combined.

### DETAILED DESCRIPTION OF SPECIFIC EMBODIMENTS

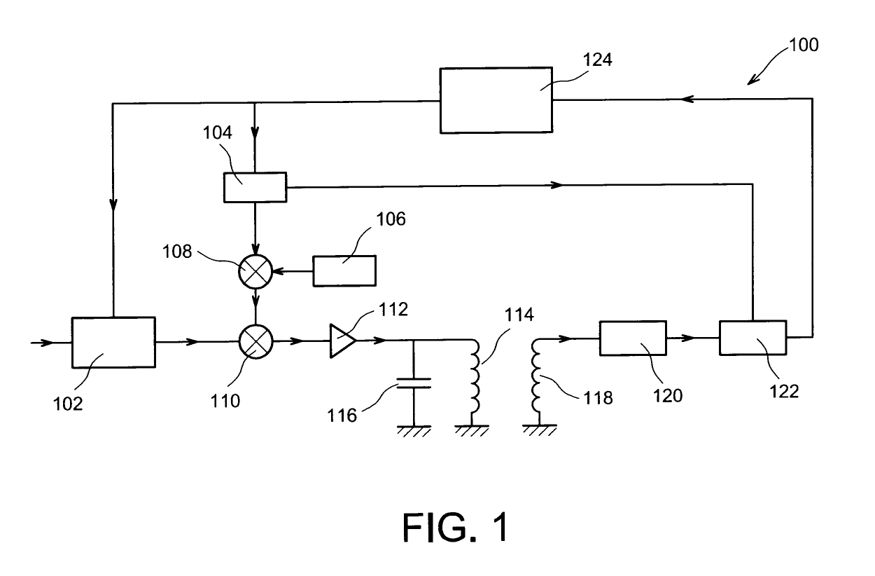

We will first refer to FIG. 1, which diagrammatically illustrates a RFID noisy reader 100 according to one specific embodiment and capable of carrying out a secure communication method with a RFID communicating object such as a RFID tag or a RFID contactless card.

The RFID noisy reader 100 includes a part intended to transmit data formed in particular by means 102 for shaping the signals intended to be transmitted by the reader 100. This means 102 here forms a digital shaping portion of bits to be transmitted. The noisy reader 100 also includes means 104 making it possible to generate a noise intended to modulate the carrier wave that will be transmitted by the reader 100 to communicate with a queried communicating object. This means 104 includes in particular one or several pseudorandom number generators used to generate the noise. This or these pseudorandom number generator(s) will also be used during the authentication phase of the reader 100 with a RFID communicating object that will be described in detail later. The reader 100 also includes means 106 for generating a carrier wave whereof the frequency is for example equal to about 13.56 MHz. The carrier wave obtained as output from the means 106 is modulated by the noise generated by the means 104 via a multiplier 108. The bits to be transmitted obtained as output from the means 102 are then modulated by the noisy carrier wave by a multiplier 110. This signal to be transmitted is then amplified by amplification means 112 and transmitted by a transmitting antenna 114. The transmission portion of the noisy reader 100 also includes a tuning capacitor 116 connected in parallel to the transmitting antenna 114.

The RFID noisy reader 100 also includes a portion intended to receive data transmitted by RFID communicating objects. This portion intended to receive data is formed at least by a receiving antenna 118 (with null mutual coupling with the transmitting antenna 114) connected to calibrating means 120 as well as to demodulating means 122. The noise generated by the means 104 is sent as input from the demodulating means 122 so that the reader 100 can find the non-noisy data sent by the RFID tag or the contactless card by removing said noise from the signal received.

The noisy reader 100 also includes means 124, connected in particular between the output of the demodulating means 122 and the shaping means 102 of the signals intended to be transmitted by the reader 100, making it possible to carry out an authentication method between the reader 100 and a RFID tag or a contactless card, which will be described in detail later. The details of producing a standard noisy reader, i.e. a noisy reader including elements 102 to 122 of the noisy reader 100, are for example described in the document <<RFID Noisy Reader—How to prevent from eavesdropping on the communication ?>> by O. Savry et al., CHES 2007, LNCS 4727, pages 334-345.

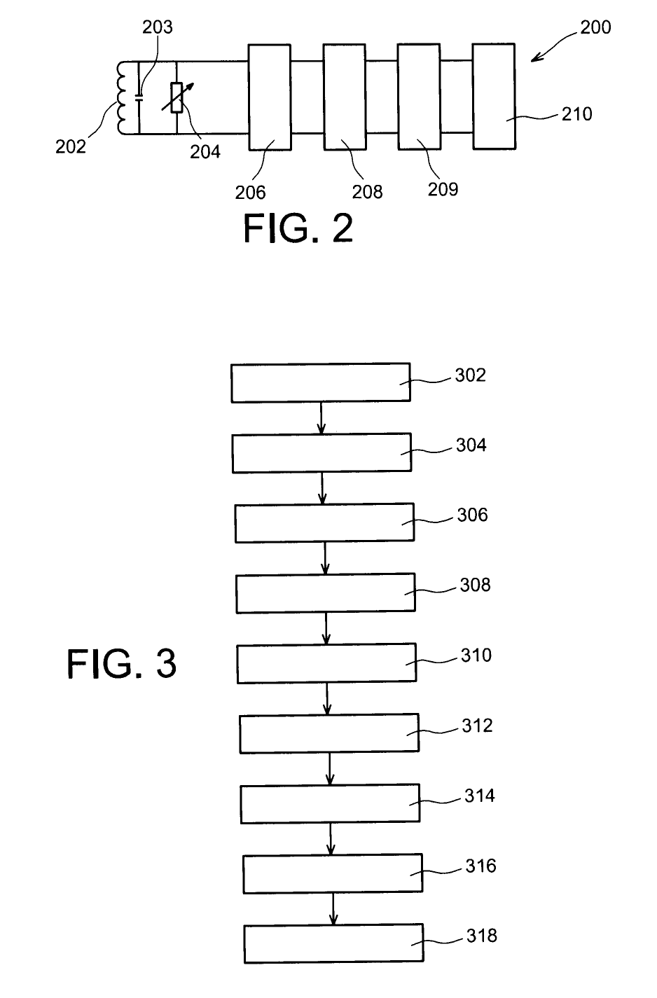

FIG. 2 shows an example of a RFID tag 200 made according to one particular embodiment and capable of carrying out a secure communication method with the noisy reader 100.

The RFID tag 200 includes an antenna 202 connected in parallel to a tuning capacitor 203 of the antenna, a variable load 204, a rectifier 206, a voltage regulator 208, means 209 for modulating and demodulating the signals as well as means 210 for digital processing of the signals received or to be transmitted.

The secure communication method carried out between the noisy reader 100 and the RFID tag 200 consists in that, parallel to the noise made by the reader 100 making it possible to secure the data transfers between the noisy reader 100 and the tag 200 when the latter sends information to the noisy reader 100, the tag 200 performs, before sending data to the reader 100, an authentication of the reader 100 in order to verify that it is indeed a reader authorized to communicate with it. This verification can for example consist of verifying that the reader 100 is indeed a noisy reader.

This authentication of the reader is done here during the so-called “anti-collision” phase during which the reader 100 identifies all of the tags located in its communication field. Indeed, RFID systems do not allow simultaneous communication between a reader and several tags. It is therefore necessary to separate communications between the reader and each of the RFID tags in order to prevent any collision between those communications. Below a standard anti-collision phase is described carried out between a RFID reader and a standard RFID tag.

The inventory of the RFID communicating objects present in the communication field of the RFID reader starts by sending a command, called “Select,” by the reader, making it possible to determine what types of tags must participate in the anti-collision phase. This “Select” command may for example make it possible to select tags or contactless cards with partially identical UIDs (or EPCs).

When the reader has selected a subset of tags or contactless cards, the reader then sends a command, called “Query,” which contains a parameter Q between 0 and 15 and which defines 2^{Q}−1 time slots. When the tags receive the “Query” command, they then each draw a pseudorandom value between 0 and 2^{Q}−1 (from a pseudorandom number generator included in the tag) that determines the time slot in which they must answer. If one or several of the tags draw the value 0, they must then immediately answer by sending to the reader a random number m coded over 16 bits. If a single tag or card answers, this means there has not been a collision. In response to the random number m sent by the tag or card, the reader then sends back an acknowledgement command “Ack” containing that random number. The tag receiving the acknowledgement command “Ack” then sends its unique identification code UID or EPC, for example encoded on 96 or 128 bits, to the reader and exits the anti-collision algorithm.

After the tag to which the first time slot was assigned sends the identification code, or after a collision of several tags if those tags answered the reader at the same time, the reader sends a command “QueryRep” lowering the value of the time slot counter for all of the tags or a “QueryAdjust” command modifying the value Q in case of collision.

It is therefore possible, for a non-noisy eavesdropping reader, to obtain from a RFID tag or a contactless card, confidential information allowing the traceability of the tag or card, and therefore the object or the person carrying it. This information, in the context of a RFID electronic tag of the type defined in the ISO 15693, ISO 18000-3 type C or EPC standards, is the unique identifying information that identifies each RFID tag or each contactless code (UID or EPC code).

We will now describe, in connection with FIG. 3, the method for authenticating the noisy reader 100 done between the noisy reader 100 and the RFID tag 200. In the example described below, this authenticating phase is carried out at the same time as an anti-collision phase.

Similarly to the standard anti-collision phase previously described, the noisy reader 100 first transmits a “Select” command making it possible to determine what types of tags must participate in the anti-collision and the authenticating phase (step 302). When the reader has selected a subset of tags, including the tag 200, the noisy reader 100 then sends a “Query” command (step 304). In response to the “Query” command, the tag 200 randomly chooses, by drawing a pseudorandom value between 0 and 2^{Q}−1, the time slot in which it will answer (step 306). The tag 200 includes, in its digital processing means 210, a pseudorandom number generator that is similar to the pseudorandom number generator of the noisy reader 100. Thus, from a same seed, these similar generators will generate similar pseudorandom numbers.

Once the time slot assigned to the tag 200 has arrived, thereby allowing the tag 200 to communicate with the reader 100, the tag 200 then draws a new pseudorandom number g coded over n bits, n being at least equal to 16 bits, from the physical pseudorandom number generator (step 308). The number of bits n conditions the security of the authentication method. The bigger n is, the longer the attacks to try to eavesdrop on the communications between the reader 100 and the tag 200 will be. The tag 200 then communicates this pseudorandom number g to the reader 100 securely, i.e. by masking g using a bijective encryption function (step 310). In one alternative, it is possible for the pseudorandom number g transmitted to the reader 100 not to be the pseudorandom number obtained as output from the physical pseudorandom number generator, but a pseudorandom number obtained as output from a pseudorandom number generator of the tag 200 using, as seed, the pseudorandom number obtained as output from the physical pseudorandom number generator.

In this embodiment, the tag 200 performs the masking of g by transmitting, to the noisy reader 100, the value (s XOR g), s being a number coded over n bits serving as secret key that is also known by the noisy reader 100 (XOR being the Exclusive OR operator). The secret key s is therefore difficult to find because g is a pseudorandom number that changes for each time slot. Moreover, the value (s XOR g) keeps its pseudorandom nature necessary for the proper unfolding of the anti-collision algorithm, this value being doubly secure due to the noise introduced by the noisy reader 100 in the answer from the tag 200 to the noisy reader 100.

From the value (s XOR g) received, the reader 100 finds the value of g by performing the opposite operation from the masking operation, i.e. (s XOR g) XOR s=g (step 312). At this stage of the authentication method, the reader 100 and the tag 200 therefore both know both values s and g. The reader 100 then uses the pseudorandom number g as seed to generate a pseudorandom number b from its pseudorandom number generator. Likewise, the tag 200 uses the pseudorandom number g as seed to generate a pseudorandom number c from its pseudorandom number generator (step 314).

The noisy reader 100 then sends the pseudorandom number b to the tag 200 (step 316). The tag 200 then compares the pseudorandom number b sent by the reader 100 with the pseudorandom number c obtained by the tag 200 (step 318). This comparison is for example carried out by storing the pseudorandom numbers b and c in the registers, then performing a bit by bit comparison of those numbers. In the present case, given that the tag 200 includes a pseudorandom number generator similar to the pseudorandom number generator of the reader 100, the pseudorandom number b obtained by the noisy reader 100 is therefore similar to the pseudorandom number c obtained by the tag 200. Thus, when the two numbers b and c are identical, this means that the reader 100 is indeed a trusted reader and that the tag 200 can then send its information (EPC or UID code) to the reader 100. If the comparison done by the tag 200 shows that the numbers are different, the tag 200 then does not send this information because such a result means that the reader is not a trusted reader.

Similarly to the standard anti-collision method previously described, the reader 100 may then send a “QueryRep” command lowering the value of the time slot counter for all of the tags or a “QueryAdjust” command changing the value of Q.

Standard RFID tags and contactless cards already have, in their memory, passwords to access the memory in writing or to destroy the tag (commonly called “kill password”) stored in registers. The secret key s can therefore be managed by the tag 200 from existing registers.

In one alternative of the authentication method previously described, it is possible for it not to be the seed g that is sent from the tag 200 to the reader 100, but the secret key s instead is sent to the reader 100 (the seed then has a fixed value and is known by the reader 100 and the tag 200).

Thus, we see that to carry out the method for authenticating the reader, the RFID noisy reader 100 therefore includes, in relation to a standard RFID noisy reader, means 124 making it possible to perform an unmasking of the pseudorandom number g by performing the operation (s XOR g) XOR s, which implies that the means 124 includes at least one Exclusive OR operator, as well as several additional registers to store the pseudorandom numbers used during the authentication of the reader (these pseudorandom numbers being generated for example by one or several pseudorandom number generators present in the means 104).

Similarly, to carry out the method for authenticating the reader, the communicating object 200 therefore includes, in relation to a standard RFID communicating object, a digital processing means 210 making it possible to perform a masking of the pseudorandom number g, implying that the means 210 includes at least one Exclusive OR operator, as well as several additional registers to store the random numbers used during the authentication of the reader (the pseudorandom numbers generated for example being obtained by one or several pseudorandom number generators present in the digital means 210).

We therefore see that this authentication method makes it possible to considerably improve the security of communications between a noisy reader and a communicating object without making the reader or the communicating object more complex, the steps carried out during the authentication in large part using material elements already present in a standard noisy reader and in a standard communicating object.

1. A method for communication between at least one RFID noisy reader and at least one RFID communicating object, including at least one method for authenticating the noisy reader done between the noisy reader and the communicating object before a transmission of data from the communicating object to the noisy reader, said data transmission being subject to a valid authentication of the noisy reader by the communicating object, and wherein the authentication method is implemented at the same time as an anti-collision method between the noisy reader and at least the communicating object.

2. The communication method according to claim 1, wherein the data transmission subject to a valid authentication of the noisy reader is a transmission of identifying data of the communicating object.

3. The communication method according to claim 1, wherein the authentication method includes at least the following steps:
generating a first pseudorandom number from a physical pseudorandom number generator of the communicating object,
masking the first pseudorandom number with at least one bijective encryption function;
sending, from the communicating object to the noisy reader, the first masked pseudorandom number,
unmasking of the first pseudorandom number by the noisy reader,
generating a second pseudorandom number from the first pseudorandom number used as seed for a pseudorandom number generator of the communicating object,
generating a third pseudorandom number from the first pseudorandom number used as seed for a pseudorandom number generator of the noisy reader similar to the pseudorandom number generator of the communicating object,
sending, from the noisy reader to the communicating object, the third pseudorandom number,
comparing the second pseudorandom number with the third pseudorandom number by the communicating object, the noisy reader being identified as valid when the second pseudorandom number is similar to the third pseudorandom number.

4. The communication method according to claim 3, wherein the bijective encryption function used to mask the first pseudorandom number includes at least one Exclusive OR operation done between the first pseudorandom number and a secret key known by the communicating object and the noisy reader, and wherein the unmasking of the first pseudorandom number by the noisy reader includes at least one Exclusive OR operation done between the first masked pseudorandom number and the secret key.

5. The communication method according to claim 3, wherein the first, second and third pseudorandom numbers are at least 16-bit binary numbers.

6. The communication method according to claim 3, also including, before the step for generating the first pseudorandom number, a step for selecting, among several communicating objects found in the communication field of the noisy reader, part of the communicating objects, and a step for assigning distinct communication time slots to each of the selected communicating objects.

7. The communication method according to claim 3, wherein the step for generating the first pseudorandom number includes generating a pseudorandom number by the physical pseudorandom number generator, then generating the first pseudorandom number from said pseudorandom number used as seed by the pseudorandom number generator of the communicating object.

8. A RFID noisy reader, including means for carrying out a communication method according to claim 1 with at least one RFID communicating object.

9. A RFID communicating object, including means for carrying out a communication method according to claim 1 with at least one RFID noisy reader.

10. The communicating object according to claim 9, said communicating object including at least one RFID tag and/or at least one RFID contactless card.

11. A RFID communication system including at least one RFID noisy reader and at least one RFID communicating object, in which the noisy reader and the communicating object include means for carrying out an authentication method of the noisy reader between the noisy reader and the communicating object before transmitting data from the communicating object to the noisy reader, said data transmission being subject to a valid authentication of the noisy reader by the communicating object, and also including means for carrying out an anti-collision method between the noisy reader and at least the communicating object at the same time as the authentication method of the noisy reader.

12. The communication system according to claim 11, including at least:
means for generating a first pseudorandom number from a physical pseudorandom number generator of the communicating object,
means for masking the first pseudorandom number with at least one bijective encryption function;
means for sending, from the communicating object to the noisy reader, the first masked pseudorandom number,
means for unmasking of the first pseudorandom number by the noisy reader,
means for generating a second pseudorandom number from the first pseudorandom number used as seed for a pseudorandom number generator of the communicating object,
means for generating a third pseudorandom number from the first pseudorandom number used as seed for a pseudorandom number generator of the noisy reader similar to the pseudorandom number generator of the communicating object,
means for sending, from the noisy reader to the communicating object, the third pseudorandom number,
means for comparing the second pseudorandom number with the third pseudorandom number by the communicating object, the noisy reader being identified as valid when the second pseudorandom number is similar to the third pseudorandom number.

13. The communication system according to claim 12, wherein the masking means includes at least one Exclusive OR operator capable of performing an Exclusive OR operation between the first pseudorandom number and a secret key known by the communicating object and the noisy reader, and wherein the unmasking means include at least one Exclusive OR operator capable of performing an Exclusive OR operation between the first masked pseudorandom number and the secret key.

14. The communication system according to claim 12, also including means for selecting, among several communicating objects located in the communication field of the noisy reader, part of the communicating objects, and means for assigning distinct communication time slots to each of the selected communicating objects.

15. The communication system according to claim 12, wherein the means for generating the first pseudorandom number include means for generating a pseudorandom number by the physical pseudorandom number generator and means for generating the first pseudorandom number from said pseudorandom number used as seed by the pseudorandom number generator of the communicating object.
